(19) United States
(12) Patent Application Publication
(10) Pub. No.: US 2017/0274950 A1
(43) Pub. Date: Sep. 28, 2017

(54) ADJUSTABLE-WIDTH CYCLING SADDLE

(71) Applicant: ALTR ERGO, LLC, Greensboro, NC (US)

(72) Inventors: William Holt, Greensboro, NC (US); Patrick Murphy, Chapel Hill, NC (US); Ty Hagler, Chapel Hill, NC (US)

(21) Appl. No.: 15/619,911

(22) Filed: Jun. 12, 2017

Related U.S. Application Data
(63) Continuation of application No. PCT/US2015/064670, filed on Dec. 9, 2015.
(60) Provisional application No. 62/091,336, filed on Dec. 12, 2014.
(60) Provisional application No. 62/243,982, filed on Oct. 20, 2015.

(51) Int. Cl. B62J 1/10; B62J 1/08; B62J 1/00

(52) U.S. Cl. CPC B62J 1/10; B62J 1/005; B62J 1/08

(57) ABSTRACT

An adjustable-width saddle includes a frame having a forward end and a rearward end, the rearward end including a laterally extending bridge, and a one-piece shell. The one-piece shell includes a forward end connected to the forward end of the frame, and a split rearward end including a first rider support and a second rider support that are supported at least in part by the bridge. The rider supports are laterally separated from the second rider support by a lateral gap that is adjustable by flexure of the one-piece shell. A lower side of each rider support defines a first channel that receives the bridge. Fasteners extend through one or more slots formed through the bridge and engage the rider supports to fix the gap at a selected width.

### CROSS-REFERENCE TO RELATED APPLICATIONS

This application is a continuation of International Patent Application Serial No. PCT/US2015/064670, entitled “ADJUSTABLE-WIDTH CYCLING SADDLE,” filed 9 Dec. 2015, which claims the benefit of and priority to U.S. Provisional Patent Application No. 62/091,336, entitled “FRAME FOR ADJUSTABLE-WIDTH BICYCLE SEAT,” filed on Dec. 12, 2014, and the benefit of priority of U.S. provisional patent application No. 62/243,982, entitled “FRAME FOR ADJUSTABLE-WIDTH BICYCLE SEAT,” filed on Oct. 20, 2015, the contents of which are incorporated by reference herein in their entireties.

### TECHNICAL FIELD

The present disclosure relates to saddles that are adjustable to suit various riders and various riding styles and conditions. More particularly, the present disclosure relates to a saddle having adjustable rear width.

### BACKGROUND

Saddles for use on bicycles are available in many sizes and styles. It is important that a saddle properly fit and support a rider. Long distance riders and frequent riders can suffer discomfort from a poorly fitting saddle. Areas of a saddle below the sitz bones must bear considerable weight. Human anatomy is variable with regard to the separation of the right and left sitz bones portions. Typical available saddles are not variable with regard to width to accommodate human anatomy variations, and what few adjustable-width saddles that have been previously contemplated have tended to include many moving parts or complex designs.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, an adjustable-width saddle includes: a frame having a longitudinal forward end and a longitudinal rearward end, the rearward end including a laterally extending bridge; and a one-piece shell. The one-piece shell includes: a forward end connected to the forward end of the frame; and a split rearward end extending rearwardly from the forward end of the shell, the split rearward end including a first rider support and a second rider support that are supported at least in part by the bridge, the first rider support being laterally separated from the second rider support by a lateral gap that is adjustable by flexure of the one-piece shell.

In at least one example, the forward end of the shell includes a nose portion; the first rider support includes a first beam connected to the nose portion, and a first seat portion connected to the first beam; the second rider support includes a second beam connected to the nose portion, and a second seat portion connected to the second beam; and the lateral gap is adjustable by flexure of at least one of the first beam and second beam.

In at least one example, the first rider support broadens from the first beam rearwardly to the first seat portion; and the second rider support broadens from the second beam rearwardly to the second seat portion.

In at least one example, a lower side of the first seat portion defines a first channel that receives a first portion of the bridge; and a lower side of the second seat portion defines a second channel that receives a second portion of the bridge.

In at least one example, the lower side of the first seat portion includes downward extending walls between which the first channel is defined; and the lower side of the second seat portion includes downward extending walls between which the second channel is defined.

In at least one example, an upper side of the bridge includes upward extending ridges; the lower side of the first seat portion includes downward extending ridges that engage a first portion of the upward extending ridges of the bridge; and the lower side of the second seat portion includes downward extending ridges that engage a second portion of the upward extending ridges of the bridge.

In at least one example, the first portion of the bridge includes a first slot; a loosenable and tightenable first fastener extends through the first slot and engages the first seat portion; the second portion of the bridge includes a second slot; a loosenable and tightenable second fastener extends through the second slot and engages the second seat portion; the lateral gap is adjustable by movement of the first seat portion when the first fastener is loosened and by movement of the second seat portion when the second fastener is loosened; and the lateral gap is fixed when the first fastener and the second fastener are tightened.

In at least one example, a first group of the upward extending ridges of the bridge surround the first slot and a second group of the upward extending ridges surround the second slot.

In at least one example, the frame includes at least one indicator that provides visual confirmation of a position of at least one of the first and second seat portions.

In at least one example, the frame includes at least one series of indicators; the first seat portion includes a first arrow indicator that provides visual confirmation of a position of first seat portion relative to the at least one series of indicators of the frame; and the second seat portion includes a second arrow indicator that provides visual confirmation of a position of second seat portion relative to the at least one series of indicators of the frame.

In at least one example, the adjustable-width saddle further includes a cover assembly including: a lower first layer including a first half portion above the first seat portion, and a separate second half portion above the second seat portion; and a second layer above the first layer an extending longitudinally forward and rearward beyond the first layer.

In at least one example, the first half portion of the first layer has a forward end that terminates above the first beam of the shell; and the first half portion of the second layer has a forward end that terminates above the second beam of the shell.

In at least one example, the first layer has a first mass density; the second layer has a second mass density; and the first mass density is less than the second mass density.

In at least one example, the second layer entirely covers the shell from above the first layers, with the first layer between the second layer and shell.

In at least one example, the cover assembly further includes a third layer that entirely covers the second layer from above.

In at least one example, an upper side of the bridge includes ridges; a lower side of the first rider support includes ridges that engage a first portion of the ridges of the bridge; and a lower side of the second rider support includes ridges that engage a second portion of the ridges of the bridge.

In at least one example, the bridge is curved and each particular ridge of the upper side of the bridge is approximately perpendicular to a tangent of the bridge.

In at least one example: the bridge includes at least one slot; a loosenable and tightenable fastener extends through the slot and engages the first rider support; the lateral gap is adjustable by movement of the first rider support when the fastener is loosened; and the first rider support is fixed relative to the bridge when the fastener is tightened.

In at least one example, the frame further includes: a forward nose plate that defines the forward end of the frame; a longitudinally-extending first rail connected to the nose plate; a longitudinally-extending second rail connected to the nose plate; a laterally extending connector connected to the first rail and to the second rail; a first strut extending upward from the first rail and connected to a first lateral end of the bridge; and a second strut extending upward from the second rail and connected to a second lateral end of the bridge.

In at least one example, the nose plate, first rail, second rail and bridge define a closed loop.

In at least one example, the connector, first strut, second strut and bridge define a second closed loop.

According to at least one embodiment, a frame for an adjustable-width saddle includes: a forward nose; a longitudinally-extending first rail connected to the nose; a longitudinally-extending second rail connected to the nose; and a laterally extending bridge supported by the first rail and second rail, the bridge including at least one slot for receiving a fastener for attaching a rear portion of a saddle shell to the bridge, and ridges for engaging a rear portion of a saddle shell.

In at least one example, he frame further includes: a laterally extending connector connected to the first rail and to the second rail; a first strut extending upward from the first rail and connected to a first lateral end of the bridge; and a second strut extending upward from the second rail and connected to a second lateral end of the bridge.

In at least one example, the nose plate, first rail, second rail and bridge define a closed loop.

In at least one example, the connector, first strut, second strut and bridge define a second closed loop.

In at least one example, the ridges surround the at least one slot.

In at least one example, the frame includes at least one indicator for provides visual confirmation of a position of a rear portion of a saddle shell.

According to at least one embodiment, a one-piece shell for an adjustable-width saddle includes: a forward end; and a split rearward end extending from the forward end of the shell, the split rearward end including a first rider support and a second rider support, the first rider support being laterally separated from the second rider support by a lateral gap that is adjustable by flexure of the one-piece shell.

In at least one example, the forward end of the shell includes a nose portion; the first rider support includes a first beam connected to the nose portion, and a first seat portion connected to the first beam; the second rider support includes a second beam connected to the nose portion, and a second seat portion connected to the second beam; and the lateral gap is adjustable by flexure of at least one of the first beam and second beam.

In at least one example: a lower side of the first rider support includes ridges for engaging a frame; and a lower side of the second rider support includes ridges for engaging the frame.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is an exploded perspective view of an adjustable-width saddle, according to at least one embodiment, including a frame, shell, and cover assembly.

FIG. 2A is a top view of the assembled saddle of FIG. 1 shown in a narrow adjusted configuration.

FIG. 2B is a top view of the assembled saddle of FIG. 1 shown in a wide adjusted configuration.

FIG. 3A is a bottom view of the assembled saddle of FIG. 1 shown in the narrow adjusted configuration of FIG. 2A.

FIG. 3B is a bottom view of the assembled saddle of FIG. 1 shown in the wide adjusted configuration of FIG. 2B.

FIG. 4 is a bottom perspective view of the assembled saddle of FIG. 1 shown in the narrow adjusted configuration of FIG. 2A.

FIG. 5 is a cross-sectional partial view, taken along the line 5-5 in FIG. 3B, of the connective components at the rear of the saddle of FIG. 1.

FIG. 6 is an exploded perspective view layers of the cover assembly of FIG. 1, according to at least one embodiment.

FIG. 7 is a perspective view of an alternative frame.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

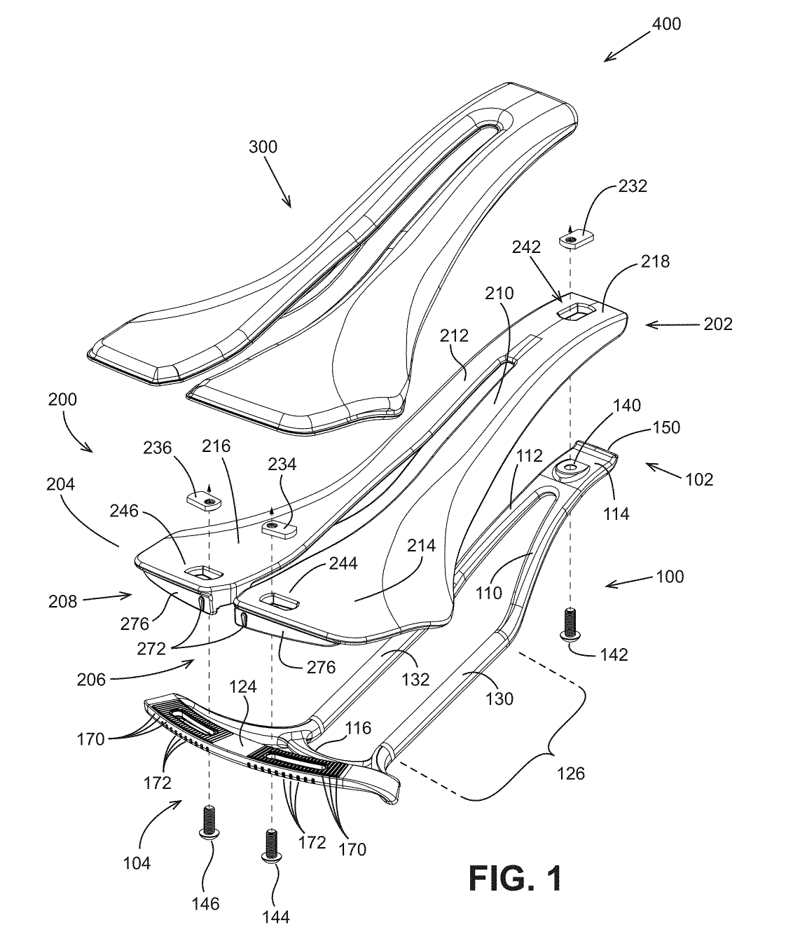

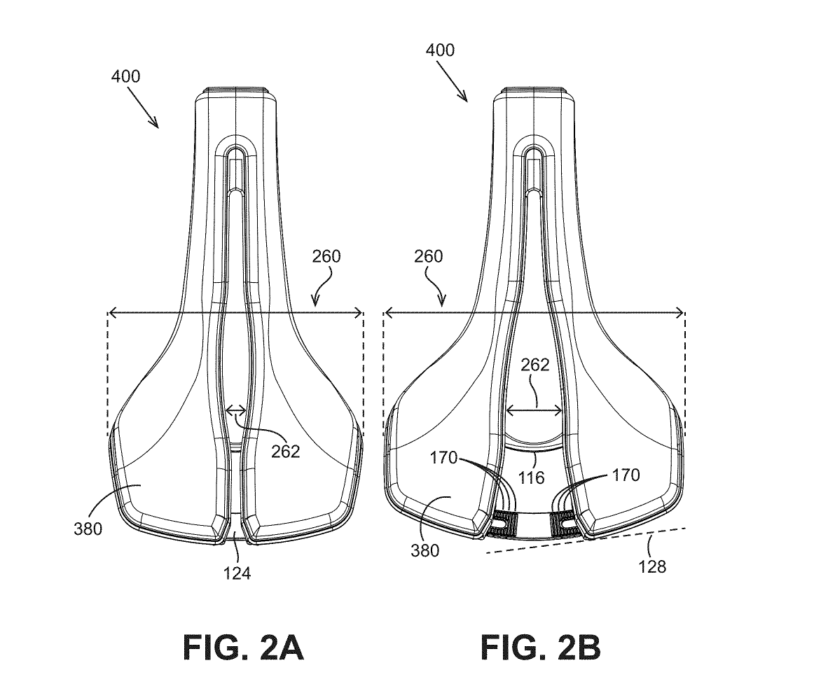

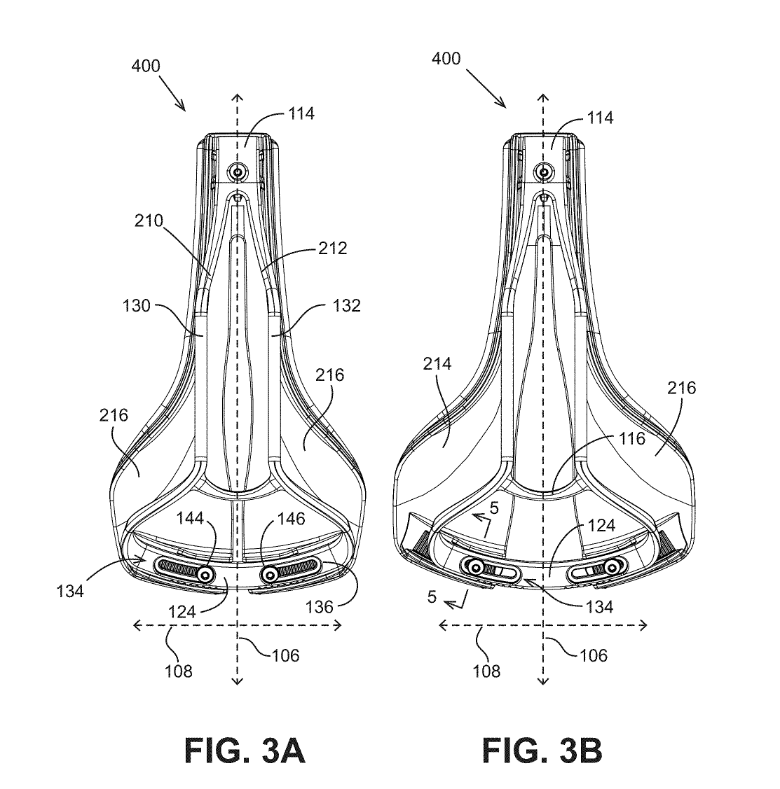

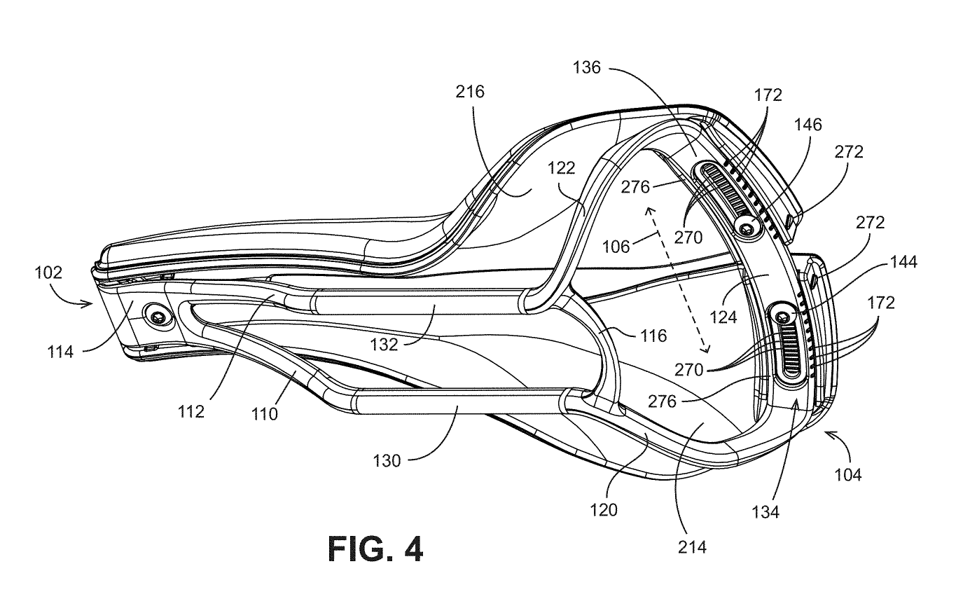

FIG. 1 is an exploded perspective view of an adjustable-width saddle 400, according to at least one embodiment, including a frame 100, a shell 200 mounted on the frame when assembled, and a cover assembly 300 mounted on the shell. The frame 100 has a forward end 102 and an opposing rearward end 104 by which a longitudinal dimension 106 (FIGS. 3A-3B) is defined for convention in the drawings and these descriptions. A lateral dimension 108 (FIGS. 2A-3A-3B) is defined as perpendicular to the longitudinal dimension 106. The forward end 102 and rearward end 104 are connected together by right and left laterally-spaced longitudinally-extending rails 110 and 112. The forward end 102 has an approximate wish-bone configuration by which the forward ends of the rails 110 and 112 are connected by a forward nose plate 114. The rearward ends of the rails 110 and 112 are connected by a lower laterally extending connector 116 (FIG. 4). Rear right and left struts 120 and 122 extend upwardly from the rearward ends of the rails 110 and 112 proximate the lateral ends of the connector 116 and support an upper laterally extending bridge 124. Right and left features of the saddle 100 are defined for convenience in the drawings and these descriptions according to right-side and left-side conventions with a rider facing the forward direction as defined by the forward end 102 of the frame 100.

The rails 110 and 112, respectively, have longitudinally extending medial sections 130 and 132 that are approximately linear and parallel. The medial section of each rail serves to adjustably secure the frame 100 to a host structure, such as a bicycle or other sport apparatus, using a clamp such that the medial sections together define a clamp area 126 (FIG. 1) of the frame 100. The longitudinal position of the frame 100 relative to a host structure can be adjusted by movement of the medial sections 130 and 132 within a loose engagement with a clamp and can be fixed by tightening of the clamp, of which there are several available varieties.

Forward ends of the rails and 110 and 112 converge toward and are connected to the forward nose plate 114. Rearward ends of the rails diverge outward and are connected to the lower connector 116. The rails 110 and 112, forward nose plate 114, and lower connector 116 define a first closed loop (FIG. 4) and an interconnected structural base that supports the upper bridge 124. In use, the upper bridge 124 particularly supports rearward portions of the shell 200 and the nose plate 114 supports a forward portion of the shell 200. The upper bridge 124 may flex under weight to absorb some riding vibration like a leaf spring. The lower connector 116, struts 120 and 122, and bridge 124 define a second closed loop.

At the rearward end of the frame 104, in each of a right section and a left section of the bridge 124 a respective laterally extending slot 134 and 136 (FIG. 4) is formed to facilitate width-adjustable connection of the shell 200 to the frame 100. A respective threaded fastener 144 and 146 (FIG. 1) passes through each slot 134 and 136 and engages a rearward portion of the shell 200. At the forward end 102 of the frame 100, a single hole 140 formed through the nose plate 114 receives a threaded fastener 142 that engages a forward portion of the shell 200. Assembly and adjustment of the saddle 400 are described in further detail below.

The shell 200 has a forward end 202 (FIG. 1) and a split rearward end 204, defined by right and left rider supports 206 and 208 that extend rearward from the forward end 202. The forward end 202 of the shell 200 has an approximate wish-bone configuration defined by a nose portion 218 from which the right and left rider supports 206 and 208 extend. The right and left rider supports 206 and 208 extend from the nose portion 218 as right and left contoured beams 210 and 212 respectively. The rider supports 206 and 208 broaden from the relatively slender beams 210 and 212 to rearward relatively wider right and left seat portions 214 and 216. In use, the slender beams 210 and 212 accommodate thigh movements of a cyclist, and the right and left seat portions 214 and 216 support any needed portion of the weight of the cyclist as the cyclist bears variable weight upon the saddle and pedals. The nose portion 218 guides the thighs of the cyclist as more forward and rearward positions of the cyclist are varied over the saddle. The nose portion 218, beams 210 and 212, and right and left seat portions 214 and 216 are smoothly contoured along upper surfaces and other edges to facilitate rider comfort.

In the illustrated embodiment, fasteners 144 and 146 (FIG. 1) have downward facing bolt heads and upwardly directed threaded shanks. The shanks pass through the slots 134 and 136 (FIG. 4) formed through the upper bridge 124 of the frame 100 (FIG. 1) and engage threaded engagers 234 and 236 retained by the right and left seat portions 214 and 216 of the shell 200. In particular in the drawings, the threaded engagers 234 and 236 are received in correspondingly shaped detents 244 and 246 formed in the upper surfaces of the right and left seat portions 214 and 216. In the illustrated embodiment, the engagers 234 and 236 are shown as nuts that are rectangular in shape, each with an offset internally threaded bore to receive and engage the respective fastener 144 or 146. The offset bores and rectangular shapes of the threaded nuts 234 and 236 withstand sufficient leverage when the corresponding fastener 144 and 146 is turned from below the saddle to secure engagement. Other threaded engagers such as hex nuts are within the scope of these descriptions.

Similarly, the threaded shank portion of the fastener 142 passes through the hole 140 in the nose plate 114 of the frame (FIG. 1), and engages a threaded nut 232 received in a correspondingly shaped detent 242 formed in the upper surface of the nose portion 218 of the shell 200. At the terminal forward end of the nose plate 114, a forward lip 150 extends upward toward and engages the nose portion 218 of the shell 200 to register relative positioning of the forward ends of the frame and shell. The engagement of the nose portion 218 and nose plate 114 may be maintained as tight and secure even throughout adjustments of the right and left seat portions 214 and 216.

In at least one embodiment, the nuts 232, 234 and 236 are press fit into the respective detents 242, 244 and 246, and are thus retained by the shell 200 by tight engagement. In at least one embodiment, the nuts 232, 234 and 236 are co-molded into or with the material of the shell 200 and are thus retained by the shell 200 by bonding or partial encasement.

The effective width 260 of the saddle 400 as shown in FIGS. 2A-2B can be adjusted by positioning of the right and left seat portions 214 and 216 (FIG. 3A-3B) upon the bridge 124. By flexure of the shell 200, for example along the slender beams 210 and 212, a variable gap 262 (FIGS. 2A-2B) between the right and left seat portions 214 and 216 can be adjusted by relative inward lateral movement of the seat portions 214 and 216 to a relatively closer proximity (FIGS. 2A and 3A) for a relatively narrowed effective width 260 of the saddle 400. Conversely, the variable gap 262 can be adjusted by relative outward lateral movement of the seat portions 214 and 216 to a relatively farther proximity (FIGS. 2B and 3B) for a relatively widened effective width 260 of the saddle 400.

In the illustrated embodiment, while the fastener 142 and nose plate 114 at the forward end 102 of the frame maintain the engagement of the forward ends of the frame 100 and shell 200, the right and left rider supports 206 and 208 of the shell 200 are connected to and joined by the nose portion 218.

In the illustrated embodiment, the shell 200 is of a one contiguous piece construction having both the strength to support a rider and the flexibility to permit width adjustment as shown in FIGS. 2A-2B. In at least one embodiment, flexure of the shell 200 for width adjustment is distributed along extended portions of the shell, for example along the relatively slender beams 210 and 212, as opposed to having discrete points of flexure or hinging, which may would cause material fatigue or may require additional components that delaminate, separate or otherwise fall apart from repeated use.

The range of movement of each seat portion 214 and 216 is defined by the extent of movement possible for the shank portion of each respective fastener 144 and 146 (FIG. 1) within the corresponding slot 134 and 136 along the bridge 124 of the frame 100. Each seat portion 214 and 216 can be independently released for movement along the along the bridge 124 by loosening of the respective fastener 144 and 146, and fixed at desired position by tightening of the fastener.

In at least one embodiment, a neutral configuration of the shell 200 without flexure is defined upon its manufacture as having the seat portions 214 and 216 at the closer proximity shown in FIGS. 2A and 3A, such that, when assembled with the other components of the saddle 400, the shank portions of each respective fastener 144 and 146 (FIG. 1) is proximal or abutting the laterally inward end of the corresponding slot 134 and 136.

Upward extending ridges 170 (FIG. 1) formed along the upper bridge 124 around the slots 134 and 136 register the position of each seat portion 214 and 216 by engaging similar ridges 270 (FIG. 4) extending downward from the seat portions of the shell. The lateral bridge 124 of the frame 100 has a curvature as shown for example in FIGS. 3A and 3B, that match corresponding arcuate movements of the seat portions 214 and 216 as their lateral positions are adjusted. Each particular ridge 170 and 270 is approximately perpendicular to the tangent 128 (FIG. 2B) of the bridge 124 at each ridge position. The ridges 170 are uniformly spaced along the bridge 124, matching the uniform lateral spacings of the ridges 270 such that the ridges 170 and 270 interlock at any position of each seat portion 214 and 216 within its adjustable range of movement. Thus, the ridges 170 and 270 assure maintenance of a selected effective width 260 (FIGS. 2A-2B) of the saddle 400 once the fasteners 144 and 146 are tightened.

In the illustrated embodiment of the frame 100, the ridges 170 are formed in a right-side group and a left-side group. Each of the slots 134 and 136 (FIGS. 3A and 3B, FIG. 4) is surrounded by slots 170 along the top side of the bridge 124. A corresponding arrangement of the slots 270 along the downward side of the saddle 200, around or proximal that receive the fasteners 144 and 146 (FIG. 1) to reach the threaded engagers 234 and 236, assures interlocking engagement of the ridges 170 of the frame 100 with the ridges 270 of the saddle 200 when the fasteners 144 and 146 are tightened.

The frame 100 includes indicators 172 that by relation to corresponding indicators 272 of the shell 200 provide visual confirmation of the position of each seat portion 214 and 216 for convenience. Thus any given adjustment of the width of the saddle can be confirmed, and previously tested configurations of the saddle can be restored permitting a rider to try various configurations in a recordable and repeatable way. For example, the indicators 172 and 272 may be used to confirm symmetry if desired and the particular placement of each seat portion. In the illustrated embodiment, the indicators 272 (FIG. 4) of the shell are shown as a respective single arrow indicator along a back face of each seat portion 214 and 216, and the indicators 172 of the frame 100 are shown as respective series of notches along the back edge of the bridge 124. Other types of indicators and arrangements thereof to provide visual confirmation of the position of each seat portion 214 and 216 are within the scope of these descriptions.

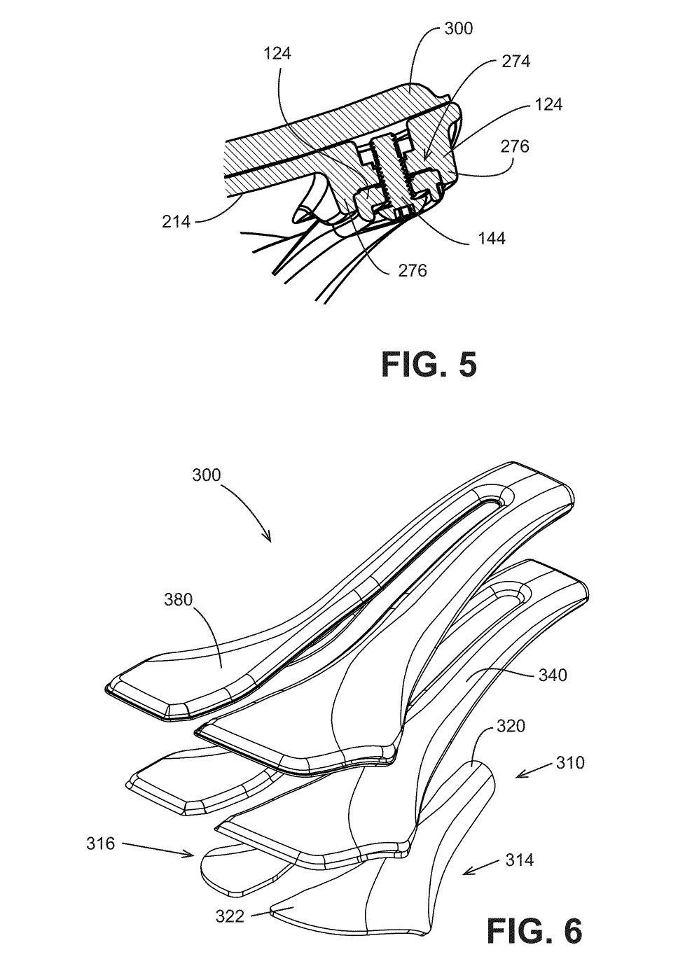

The lower side of each seat portion 214 and 216 of the shell 200 defines a channel 274 that receives a respective portion of the bridge 124. For example, as shown in FIG. 5, the right-side seat portion 214 has downward extending walls 276 between which the right-side channel 274 is formed. The channel 274 matches the curvature of the bridge 124 permitting smooth arcuate movements of the seat portion 214 and 216 as their lateral positions are to be adjusted. The walls 276 facilitate force distribution, particularly longitudinal forces, between the shell 200 and frame 100 and thus serve to minimize material fatigue, particularly for example of the bridge 124 and seat portions 214 and 216 proximal the fasteners 144 and 146 positions.

The channels 274, ridges 170 and 270, and indicators 172 and 272 together constitute an advantageous and interacting system of features by which a durable saddle 400 permits variable width adjustment that can be confirmed and restored to any desired configuration permitting a rider to try various configurations in a recordable and repeatable way.

The cover assembly 300, in at least one embodiment, is a layered assembly having additional advantages. As shown in FIG. 6, the cover assembly 300 in the illustrated embodiment includes a lower first layer 310 closest to the shell 200, a second intermediate layer 340, and an upper third layer 380 furthest from the shell, and closest to a rider when in use.

In the illustrated embodiment, the first layer 310 includes two separated symmetric half portions 314 and 316. A right half portion 314 is sized, dimensioned and arranged to cover only a limited portion of the right seat portion 214 (FIG. 1) of the shell 200. Similarly, a left half portion 316 (FIG. 6) is sized, dimensioned and arranged to cover only a limited portion of the left seat portion 216 (FIG. 1). The half portions 314 and 316 of the first layer 310 cover an area of the shell expected to be under the sitz bone portions of a rider when in use, and thus do not extend entirely to cover the nose-portion 218 of the shell. In particular, the right half portion 314 (FIG. 6) of the first layer 310 extends longitudinally from a forward end 320 to a rearward and 322 thereof. The forward end 320 terminates above the right beam 210 portion of the shell 200 (FIG. 1). The rearward end 322 of the right half portion 314 (FIG. 6) of the first layer 310 terminates above the right seat portion 214 of the shell 200 (FIG. 1) forward of the rearward edge of the right seat portion. The left half portion 316 of the first layer 310 is similarly shaped, dimensioned, and arranged in relation to the left seat portion 214 of the shell 200, in symmetry with the right half portion 314.

In the illustrated embodiment, the second layer 340 extends forwardly and rearwardly beyond the first layer 310 half portions 314 and 316, and entirely covers the shell 200 above the first layer. The third layer 380 entirely covers the second layer 340. The third layer 380 protects the second layer 340 from outdoor elements and rider movement abrasion. The third layer 380 may be constructed of natural or synthetic materials including leather and plasticized fabric.

In at least one embodiment of the cover assembly 300, the first and second layers 310 and 340 are constructed of resilient cushioning materials for the comfort of a rider. Furthermore, in at least one embodiment, the first and second layers 310 and 340 are constructed of different respective foam materials. Furthermore, in at least some examples, the first and second layers 310 and 340 are formed of different materials of different density. In such examples, the first layer is relatively softer and less firm than the second layer, which is harder and more firm than the first layer. Furthermore, in at least one particular such example, the first layer 310 includes material having a first mass density, the second layer 340 includes material having a second mass density, and the first mass density is lower than the second mass density.

In at least one embodiment, the first and second layers 310 and 340 are each constructed of a different respective foam material. As such, the first and second layers 310 and 340 may be selected from PORON® materials, which are fine pitch open cell urethane foam products. In at least one example of such an embodiment, the first layer 310 includes a PORON® SRSMA material, and the second layer 340 includes a PORON® XRD material. Such an example is advantageous toward damping both impact transfer from the shell to a rider, and vibration transfer from the shell to a rider. Testing has been conducted upon such an example and advantageous results have been discovered when: the first layer 310 is constructed to have a relatively lower density PORON® SRSMA material, apparently damping lower frequency motion corresponding to impact transfer; and the second layer 340 is constructed to have a relatively higher density PORON® XRD material, apparently damping higher frequency motion corresponding to vibration transfer.

In at least one exemplary embodiment, the first layer 310 is approximately 5.0 to 6.0 millimeters thick, and the second layer 340 is approximately 10.0 to 12.0 millimeters thick.

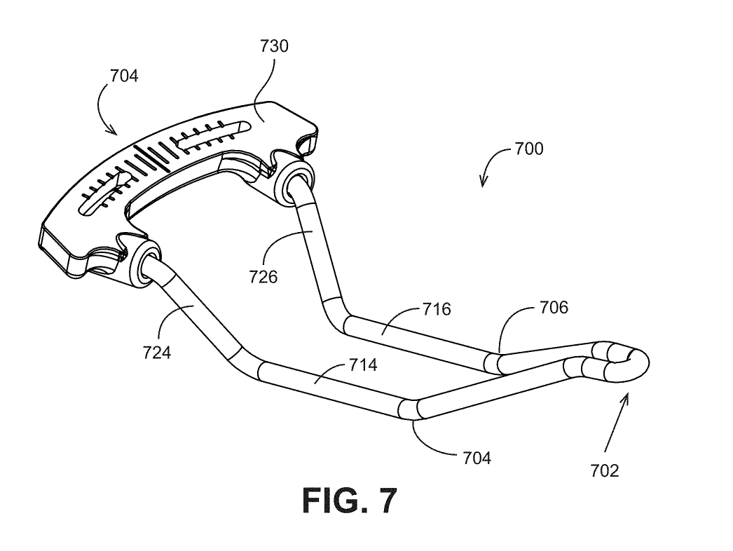

FIG. 7 is a perspective view of an alternative embodiment of a frame 700 for an adjustable-width saddle. The frame 700 includes a forward end 702 defined by the U-shaped forward junction of longitudinally extending right and left rails 704 and 706. Strut portions 724 and 726 of the rails extend upward from the lower parallel linear medial portions 714 and 716 to a laterally extending bridge 730 at the rearward end 704 of the frame. In the illustrated embodiment, the rails 704 and 706, the medial portions 714 and 716, and the strut portions 724 and 726 are all formed from a single contiguous rod formed into the illustrated shape. The bridge 730 is connected to rearward ends of the rod. The frame 700 has many advangeous features in similarity to the frame 100 such that the above descriptions of slots 134 and 136 permitting positional adjustment of shell portions and upward ridges 170 to engage corresponding downward ridges of the shell 200 apply to similarly illustrated features of the frame 700 in FIG. 7.

Various examples of seat frames constructed according to the drawings and detailed in these descriptions may be constructed of materials expressly indicated herein and/or other materials. The rails may be of metallic construction. For example the rails may be constructed of titanium for strength and weight advantages. Other portions of the seat frames may be constructed in whole or in part of carbon fiber composite materials, aluminum, steel, plastic and other manmade and natural materials.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. An adjustable-width saddle comprising:
a frame having a longitudinal forward end and a longitudinal rearward end, the rearward end including a laterally extending bridge;
a one-piece shell comprising:
a forward end connected to the forward end of the frame; and
a split rearward end extending rearwardly from the forward end of the shell, the split rearward end including a first rider support and a second rider support that are supported at least in part by the bridge, the first rider support being laterally separated from the second rider support by a lateral gap that is adjustable by flexure of the one-piece shell;
wherein the bridge comprises at least one slot for receiving a fastener for attaching at least one of the first rider support and second rider support to the bridge.

2. The adjustable-width saddle of claim 1, wherein:
the forward end of the shell comprises a nose portion;
the first rider support comprises a first beam connected to the nose portion, and a first seat portion connected to the first beam;
the second rider support comprises a second beam connected to the nose portion, and a second seat portion connected to the second beam; and
the lateral gap is adjustable by flexure of at least one of the first beam and second beam.

3. The adjustable-width saddle of claim 2, wherein an upper side of the bridge comprises upward extending ridges that engage the first seat portion and second seat portion.

4. The adjustable-width saddle of claim 2, wherein:
the at least one slot comprises a first slot in the first portion of the bridge and a second slot in the second portion of the bridge;
a loosenable and tightenable first fastener extends through the first slot and engages the first seat portion;
a loosenable and tightenable second fastener extends through the second slot and engages the second seat portion;
the lateral gap is adjustable by movement of the first seat portion when the first fastener is loosened and by movement of the second seat portion when the second fastener is loosened; and
the lateral gap is fixed when the first fastener and the second fastener are tightened.

5. The adjustable-width saddle of claim 4, wherein a first group of the upward extending ridges of the bridge surround the first slot and a second group of the upward extending ridges surround the second slot.

6. The adjustable-width saddle of claim 2, wherein the frame comprises at least one indicator that provides visual confirmation of a position of at least one of the first and second seat portions.

7. The adjustable-width saddle of claim 2, wherein:
the frame comprises multiple indicators;
the first seat portion comprises a first arrow indicator that provides visual confirmation of a position of the first seat portion relative to the multiple indicators of the frame; and
the second seat portion comprises a second arrow indicator that provides visual confirmation of a position of second seat portion relative to the multiple indicators of the frame.

8. The adjustable-width saddle of claim 2, further comprising a cover assembly, the cover assembly comprising:
a lower first layer including a first half portion above the first seat portion, and a separate second half portion above the second seat portion; and
a second layer above the first layer and extending longitudinally forward and rearward beyond the first layer.

9. The adjustable-width saddle of claim 8, wherein:
the first half portion of the first layer has a forward end that terminates above the first beam of the shell; and
the second half portion of the first layer has a forward end that terminates above the second beam of the shell.

10. The adjustable-width saddle of claim 8, wherein: the first layer has a first mass density; the second layer has a second mass density; and the first mass density is less than the second mass density.

11. The adjustable-width saddle of claim 8, wherein the second layer entirely covers the shell from above the first layers, with the first layer between the second layer and shell.

12. The adjustable-width saddle of claim 11, the cover assembly further comprising a third layer that entirely covers the second layer from above.

14. The adjustable-width saddle of claim 1, wherein:
an upper side of the bridge comprises ridges;
a lower side of the first rider support comprises ridges that engage a first portion of the ridges of the bridge; and
a lower side of the second rider support comprises ridges that engage a second portion of the ridges of the bridge.

15. The adjustable-width saddle of claim 14, wherein the bridge is curved and each particular ridge of the upper side of the bridge is approximately perpendicular to a tangent of the bridge.

16. The adjustable-width saddle of claim 1, wherein the frame further comprises:
a forward nose plate that defines the forward end of the frame;
a longitudinally-extending first rail connected to the nose plate;
a longitudinally-extending second rail connected to the nose plate;
a first strut extending upward from the first rail and connected to a first lateral end of the bridge; and
a second strut extending upward from the second rail and connected to a second lateral end of the bridge;
wherein the nose plate, first rail, first strut, bridge, second strut and second rail define a closed loop.

17. A frame for an adjustable-width saddle, the frame comprising:
a forward nose;
a longitudinally-extending first rail connected to the nose;
a longitudinally-extending second rail connected to the nose; and
a laterally extending bridge supported by the first rail and second rail, the bridge comprising at least one slot for receiving a fastener for attaching a rear portion of a saddle shell to the bridge, and ridges for engaging a rear portion of a saddle shell.

18. The frame of claim 17, further comprising:
a first strut extending upward from the first rail and connected to a first lateral end of the bridge; and
a second strut extending upward from the second rail and connected to a second lateral end of the bridge,
wherein the nose plate, first rail, first strut, bridge, second strut and second rail define a closed loop.

19. The frame of claim 17, wherein the ridges surround the at least one slot.

20. The frame of claim 17, wherein the frame comprises at least one indicator for provides visual confirmation of a position of a rear portion of a saddle shell.
